(19) United States
(12) Patent Application Publication
(10) Pub. No.: US 2026/0013447 A1
(43) Pub. Date: Jan. 15, 2026

(54) IRRIGATION SYSTEM HAVING IMPROVED END SEGMENTS FOR REDUCING WATER DISTRUBUTION DEAD ZONES

(71) Applicant: Reinke Manufacturing Co., Inc., Deshler, NE (US)

(72) Inventors: Brennan Joos ZIEGELMEIER, Colby, KS (US); Darin Joseph Neff, Hebron, NE (US); Russell Scott Reinke, Davenport, NE (US); Mark Randall Virus, Hebron, NE (US)

(21) Appl. No.: 18/771,847

(22) Filed: Jul. 12, 2024

(51) Int. Cl. A01G 25/09

(52) U.S. Cl. CPC A01G 25/09

(57) ABSTRACT

An irrigation system having spans of a variable overall length is provided. Each span has a plurality of fluid delivery conduits coupled end to end to define the span with a first peripheral end and a second peripheral end. Each fluid delivery conduit has a plurality of receptacles uniformly spaced along its length. The first peripheral end has a first end segment and the second peripheral end has a second end segment. The lengths of the first and second end segments are less than half of the uniform distance by which each of the plurality of receptacles is spaced apart. Uniform spacing of receptacles is maintained across a connection of adjacent spans.

### TECHNICAL FIELD

Aspects provided relate to irrigation systems. More specifically, aspects provided relate to an improved irrigation system for agricultural settings where the end segments of each span are designed to reduce the water distribution dead zones when connecting multiple spans together.

### BACKGROUND

Agricultural irrigation systems generally include a pipeline adapted to communicate fluid from a fluid source to a field. The pipeline is typically supported above the field by one or more towers and a trussing system. In large fields, the pipeline includes multiple spans connected to one another to cover the full area of the field.

However, in doing so, the end segments of each span in prior art irrigation systems produce locations in which water distribution receptacles are not uniformly spaced along the full length of the pipeline. The result of not having uniformly spaced receptacles means that there are water distribution “dead zones”, where certain segments of the field do not receive proper irrigation. It is thus the aim of this invention to provide spans having improved end segments that eliminate or significantly reduce water distribution “dead zones”, such that fields receive uniform water distribution.

### SUMMARY

The present disclosure generally relates to irrigation systems for use in agricultural settings. At a high level, aspects herein are directed an irrigation system having a variable overall length by way of coupling together multiple spans, or by varying the length of the pipes used within each span. Each span comprises a plurality of fluid delivery conduits having a plurality of receptacles spaced along a length of the plurality of fluid delivery conduits, wherein the plurality of fluid delivery conduits comprises a first peripheral end and a second peripheral end, a first end segment coupled to the first peripheral end and a second end segment coupled to the second peripheral end, each of the first end segment and the second end segment having a length that is shorter than the length of the plurality of fluid delivery conduits. The irrigation system also comprises a trussing system coupled to the first peripheral end and the second peripheral end of the plurality of fluid delivery conduits, wherein the trussing system comprises a plurality of support structures coupled to the plurality of fluid delivery conduits, wherein each of the plurality of receptacles is spaced apart by a uniform distance, wherein the length of the first end segment and the length of the second end segment is less than half of the uniform distance by which each of the plurality of receptacles is spaced apart.

In another example, aspects herein are directed to an array of spans coupled together to form an irrigation system. The array of spans comprises at least a first span and a second span, each of the first span and the second span comprising a plurality of fluid delivery conduits having a plurality of receptacles spaced along the plurality of fluid delivery conduits, wherein the plurality of fluid delivery conduits comprises a first peripheral end and a second peripheral end. Each span comprises a first end segment coupled to the first peripheral end and a second end segment coupled to the second peripheral end, each of the first end segment and the second end segment having a length that is shorter than the length of the plurality of fluid delivery conduits, and a trussing system coupled to the first peripheral end and the second peripheral end of the plurality of fluid delivery conduits, wherein the trussing system comprises a plurality of support structures coupled to the plurality of fluid delivery conduits, wherein each of the plurality of receptacles is spaced apart by a uniform distance, and wherein the length of the first end segment and the length of the second end segment is less than half of the uniform distance by which each of the plurality of receptacles is spaced apart. Finally, when the first span and the second span are coupled together, the second end segment of the first span and the first end segment of the second span are coupled together, such that the uniform distance between the plurality of receptacles is maintained across the connection between the first span to the second span.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 depicts a side elevation view of a section or initial span of an irrigation system, in accordance with aspects hereof;

FIG. 2 is a top plan view of the irrigation system of FIG. 1;

FIG. 3 is a fragmentary side elevation view of a receptacle portion of the irrigation system of FIG. 1;

FIG. 4 is a fragmentary top plan view of a receptacle portion of the irrigation system of FIG. 2;

FIG. 5 is a schematic side elevation view of a variable length span of an irrigation system having a plurality of receptacles, in accordance with aspects hereof;

FIG. 6 is a schematic side elevation view of a variable length span of an irrigation system having uniformly spaced receptacle portions and uniform pipe lengths, in accordance with aspects hereof;

FIG. 7 is a fragmentary side elevation view of a connection of a pair of coupled end portions of adjacent spans, in accordance with aspects herein;

FIG. 7B is a fragmentary side elevation view of a connection of a pair of coupled end portions of adjacent spans, in accordance with the prior art;

FIG. 8 is a side elevation view of two spans constructed in accordance with aspects of the present invention coupled together;

FIG. 9A depicts a schematic top plan environmental view of and irrigation system with prior art spans operating in a field;

FIG. 9B depicts a schematic top plan environmental view of and irrigation system with spans implementing the present invention operating in a field;

FIG. 10 is an alternate schematic side elevation view of a variable length span of an irrigation system having uniformly spaced receptacle portions and uniform pipe lengths, in accordance with aspects hereof; and

FIG. 11 is another alternate schematic side elevation view of a variable length span of an irrigation system having uniformly spaced receptacle portions and uniform pipe lengths, in accordance with aspects hereof.

### DETAILED DESCRIPTION

The subject matter of the present invention is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” and/or “block” might be used herein to connote different elements of methods employed, the terms should not be interpreted as implying any particular order among or between various steps herein disclosed unless and except when the order of individual steps is explicitly stated.

Aspects hereof may be described using relative location terminology. For example, the term “proximate” is intended to mean on, about, near, by, next to, at, and the like. The term “about” when used in relation to measurements means within ± 10% of a designated value. Therefore, when a feature is proximate another feature, it is close in proximity but not necessarily exactly at the described location or in abutting contact, in some aspects. Additionally, the term “distal” refers to a portion of a feature herein that is positioned away from a midpoint of the feature. Terms such as “coupled,” “attached,” “fastened,” “secured,” “affixed,” and the like may mean elements that are releasably attached or connected to one another using, for example, bolts and the like. These terms may further mean elements that are permanently attached to one another using, for example, rivets, welding, and the like.

The term “releasable fastener” as used herein refers to a fastener system that can be repeatedly, selectively, coupled and uncoupled to respectively secure or disengage components from each other. In line with this, the term “complementary” when describing components of a releasable fastener system means components having structures that mechanically engage with each other (e.g., a nut and a bolt may mechanically engage one another at threads formed thereon).

The term “end” when used in relation to the end of a pipeline, rail, or trussing rod may mean a terminal edge of said component. Such term may also mean a portion of the pipeline, rail, or trussing rod within about 12 inches of the terminal edge of said component. The terms “axial direction” and “longitudinal direction” are used interchangeably herein and mean the direction the pipeline, rail, or trussing rod extends from a first end of said component to a second end of said component. The term “substantially” when used in relation to positional descriptions means primarily.

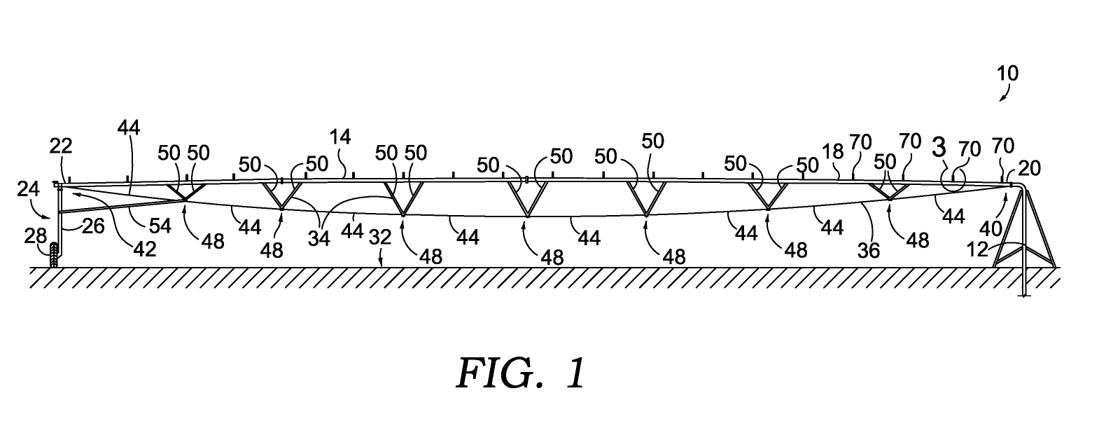

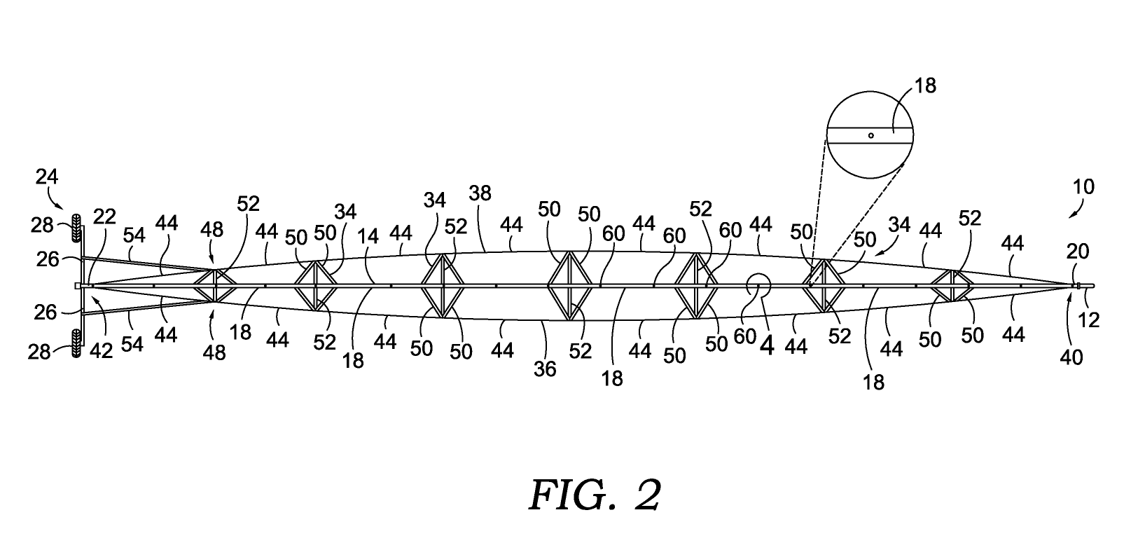

Referring now initially to FIG. 1, a side or elevation view of an irrigation system 10 of the present invention is illustrated. In FIG. 2, a top plan view of the irrigation system 10 of FIG. 1 is illustrated. The illustrated irrigation system 10 is a center-pivot type irrigation system that revolves or rotates around a fluid source 12. In other aspects, however, the irrigation system may be a linear or lateral move irrigation system, or any other type of irrigation system. The irrigation system 10 includes a plurality of fluid delivery pipes or conduits 14 coupled together and, ultimately, to the fluid source 12. The plurality of fluid delivery conduits 14 extend from the fluid source 12 to a mobile tower 24, thereby representing an initial or first span of the irrigation system 10. As discussed in more detail below, multiple spans may be coupled together to expand the coverage area of the irrigation system 10.

When coupled together, the plurality of fluid delivery conduits 14 generally form a continuous pathway for fluid to flow through. In other words, the plurality of fluid delivery conduits 14 are coupled together to form a single piping structure for fluid to flow within. However, in other aspects, the plurality of fluid delivery conduits 14 may comprise a single pipe segment. When discussing the plurality of fluid delivery conduits 14 herein, discussions may be related the plurality of fluid delivery conduits 14 in a disassembled form (i.e. each conduit separately), or discussions may be related to the plurality of fluid delivery conduits 14 in an assembled form (as illustrated in FIGS. 1 and 2).

A first end segment 20 of the plurality of fluid delivery conduits 14 may connect to the fluid source 12 with a span coupling. The first end segment 20 may include the span coupling, or a portion of the span coupling (e.g., a hook), for detachably coupling to the fluid source 12. The span coupling may comprise a hook and receiver type span coupling. For example, the first end segment 20 may include a hook that may be detachably coupled to a receiver (e.g., a ring) connected to the fluid source 12. Such a span coupling may provide a highly efficient point of rotation for the plurality of fluid delivery conduits 14 when placed in the center of the plurality of fluid delivery conduits 14.

In the illustrated embodiment of a single span, the plurality of fluid delivery conduits 14 have a second end segment 22 at a distal end. Generally it is advantageous to provide a multi-span irrigation system to permit irrigation of a greater area. For example, the irrigation system 10 may comprise a first span, a second span, multiple additional spans, and may terminate in an ancillary span or a swing arm that is attached to the final span. Thus, a multi-span irrigation system may be composed of two or more spans which cooperate together to form a single length of the irrigation system 10. Accordingly, in embodiments, the second span, ancillary span, or swing arm may be coupled to the second end segment 22 of the plurality of fluid delivery conduits 14 of the irrigation system 10 to increase the area over which the irrigation system 10 travels. Thus, the second end segment 22 of the plurality of fluid delivery conduits 14 may include a span coupling (e.g., a hook and a receiver), or a portion of a span coupling, (e.g., a receiver) for connecting to a span coupling (e.g., a hook) of the second span, ancillary span, or swing arm. Hook-and-receiver type span couplings known in the art are preferred, but other types of span couplings may also be useful with the present invention.

The mobile tower 24 supports the second end segment 22 of any individual span. In other aspects, the mobile tower 24 may support an intermediate portion of multiple spans that have been coupled together resulting in a portion of the plurality of fluid delivery conduits 14 cantilevered past the mobile tower 24 (e.g., an ancillary span). The mobile tower 24 includes one or more support legs 26 and one or more wheels 28. In some aspects, the mobile tower 24 is self- propelled and includes a drive unit that causes the wheels to rotate to move the plurality of fluid delivery conduits 14 over a field 32. In other aspects, other equipment (e.g., electronics) may be mounted on the mobile tower 24.

A trussing system 34 includes a first truss rail 36 and a second truss rail 38 (best illustrated in FIG. 2). In some embodiments, the trussing system 34 may include only one truss rail. In other aspects, the trussing system 34 may include more than two trussing rails. The first truss rail 36 and the second truss rail 38 are substantially similar and the following description of the first truss rail 36 applies equally to the second trussing rail 38. A first end 40 of the first truss rail 36 is coupled to the first end segment 20 of the plurality of fluid delivery conduits 14. Likewise, a second end 42 of the first truss rail 36 is coupled to the second end segment 22 of the plurality of fluid delivery conduits 14. The first truss rail 36 and second truss rail 38 are generally formed by a plurality of rail segments or truss rods 44 connected together end to end.

The trussing system 34 also includes a plurality of pairs of struts 50 extending from the plurality of fluid delivery conduits 14 to which they are coupled via conventional means (e.g., fastened via bolts to a plate that is welded to the plurality of fluid delivery conduits 14). Each pair of struts 50 additionally is coupled to each other at one of the intermediate joints 48, as more fully described below. The trussing system 34 further includes a plurality of cross-members 52 (FIG. 2). Each said cross-member 52 extends from one of the intermediate joints 48 of the first truss rail 36 to an intermediate joint of the second truss rail 38 and spaces the intermediate joints, and thereby the first and second trussing rails 36, 38, apart. In the illustrated embodiment, a brace 54 also extends from the mobile tower 24 to one of the intermediate joints 48 (best seen in FIGS. 1 and 2) to provide additional support and to stabilize the mobile tower 24. In some aspects, one or more of the intermediate joints may comprise flying joints that do not have a strut 50, a cross-member 52, or a brace 54 attached.

In the illustrated irrigation system 10 depicted in FIGS. 1 and 2, the span further comprises a plurality of receptacles 60 spaced along the length of the fluid delivery conduits 14. In accordance with aspects herein, the plurality of receptacles 60 are generally known to be the female mating connection point for a water distribution mechanism, such as a sprinkler. In other words, the water distribution mechanism is commonly (but not always) a separate component, which needs to be coupled to the plurality of fluid delivery conduits 14. The location at which the coupling is done is generally at each of the plurality of receptacles 60 discussed herein, with the plurality of receptacles 60 playing the female role in the coupling process. In other words, the water distribution mechanism plays the male role when coupled to the plurality of receptacles 60. In FIGS. 1 and 2, the plurality of receptacles 60 are generally illustrated as radial, although other shapes are considered to be within the scope of this disclosure. For example, the plurality of receptacles 60 may be square, rectangular, circular, ovular, triangular, or any other standard geometric shape.

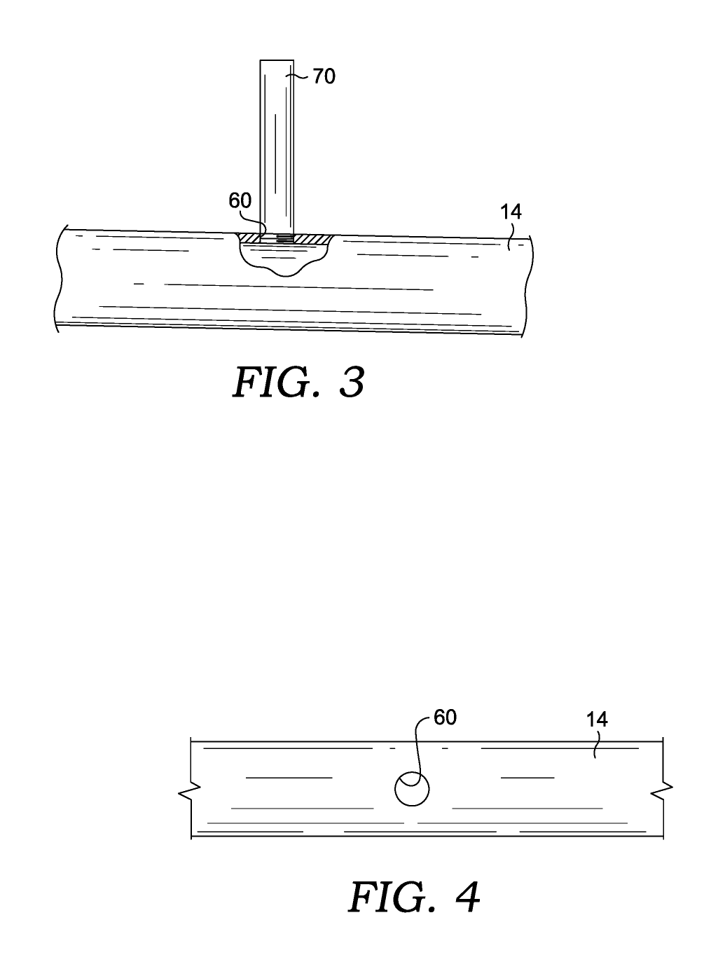

Turning now to FIGS. 3 and 4, a water distribution mechanism 70 is illustrated as coupled to one of the plurality of fluid delivery conduits 14 by way of the a receptacle 60. FIG. 3 depicts a side view of this structure and FIG. 4 depicts a top view of this structure. As discussed herein, the specific shape of the male and female connections is variable, with the shapes of round, radial, square, rectangular, circular, ovular, triangular, or any other standard geometric shape considered to be within the scope of this disclosure. Furthermore, the water distribution mechanism 70 may be a sprinkler, although other types of water distribution mechanisms (such as a fountain) are also considered to be within the scope of this disclosure.

Generally, each of the plurality of receptacles 60 should have a respective water distribution mechanism 70 coupled thereto. In other words, along the length of the plurality of fluid delivery conduits 14, there should be an equal number of the plurality of receptacles 60 and the plurality of water distribution mechanisms 70. The coupling mechanism used to connect the water distribution mechanism 70 to the plurality of receptacles can be any number of mechanical couplings, such as a threated coupling, a jaw coupling, a sleeve coupling, a flange coupling, a gear coupling, a magnetic coupling, a or “Hooke’s Joint” type coupling.

In accordance with aspects herein, the water distribution mechanism 70 depicted in FIGS. 3 and 4 may spray in a linear pattern, a “cone” pattern, an angled pattern, or may spray in a full 360 degrees. Moreover, in the event that the water distribution mechanism 70 sprays in a linear pattern, a “cone” pattern, or an angled pattern, it is understood that the specific direction that the water distribution mechanism is spraying may change over time. The directional change discussed herein may be controlled mechanically or electronically by way of coupling to a computing device.

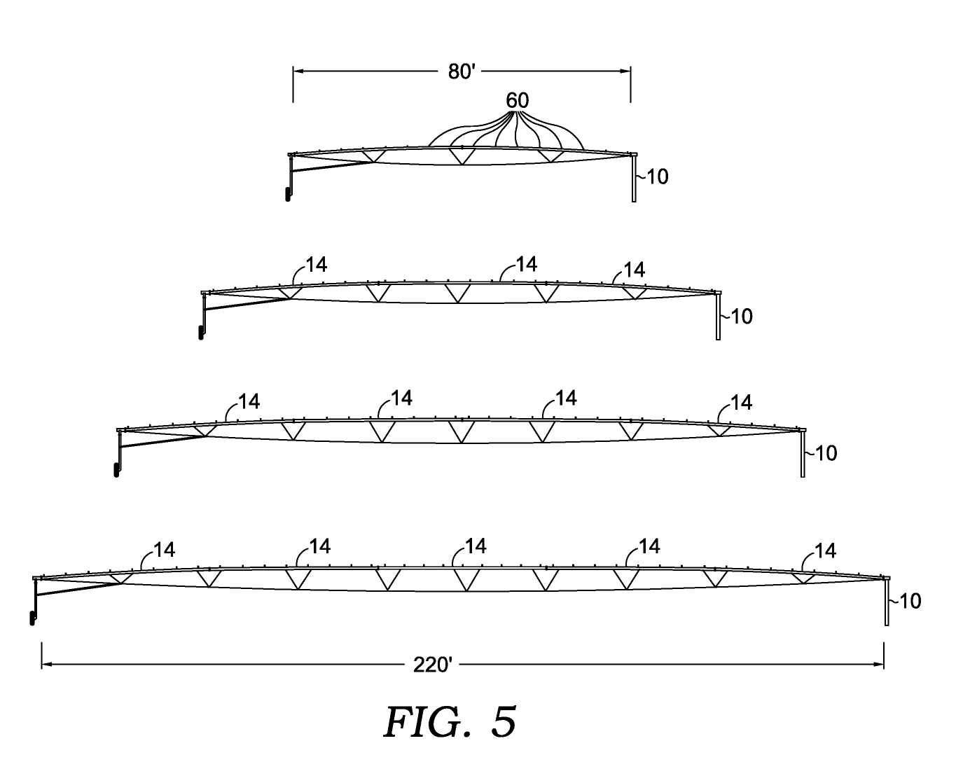

Turning now to FIG. 5, a schematic side elevation view of spans of variable length are depicted. The spans have a plurality of receptacles 60 in accordance with aspects hereof. In FIG. 5, each of the examples are depicted as a single span. However, as discussed herein, the concept of multiple span irrigation systems is heavily contemplated. In aspects in which multiple spans are used, a first span and a second span would be coupled together and supported by a tower, which is discussed further herein. Thus, in some embodiments the desired coverage of the irrigation system 10 may be achieved by a single span or by multiple shorter spans to achieve the same length. In other words, as discussed herein, an irrigation system may be a single span or multiple spans coupled together.

When looking at FIG. 5, it is important to note that the spacing between each of the plurality of receptacles 60 remains constant regardless of the number and total length of the plurality of fluid delivery conduits 14. For example, the span at the top of FIG. 5 is illustrated to be 80 feet in total length and the span at the bottom of FIG. 5 is illustrated to be 220 feet in total length. However, despite the difference in length between these two irrigation systems, the spacing between each of the plurality of receptacles remains 5 feet, even across a coupling between two fluid deliver conduits 14. It is important to note that in illustrated embodiments in FIG. 5, each of the plurality of fluid delivery conduits 14 is the same length across the entire length of each span. Specifically, the span at the top of FIG. 5 contains two 38’ fluid delivery conduits 14, while the span directly beneath it contains three 38’ fluid delivery conduits 14. In other words, each of the spans depicted in FIG. 5 contains a plurality of fluid delivery conduits 14 having the same standard 38’ length throughout the overall length of the span.

Moreover, it is contemplated herein that the receptacle spacing remains constant across the length of each span, although the actual value for the spacing between the plurality of receptacles 60 may also change based on irrigation requirements. For example, if a setting where an agricultural product requires a lot of water, then the spacing between each of the plurality of receptacles 60 may be as low as 2 feet. In another scenario where the agricultural product requires less water, the spacing between each of the plurality of receptacles 60 may be as much as 5 feet. Embodiments where the spacing between each of the plurality of receptacles 60 are 30 inches or 60 inches have been found beneficial. When choosing the overall length of the each span, the spacing between each of the plurality of receptacles 60 must be taken into account. For example, if the spacing between each of the plurality of receptacles 60 is 5 feet, then the overall length of the span must be divisible by 5 feet, so as to maintain uniform spacing between each of the plurality of receptacles 60. Likewise, if the spacing between each of the plurality of receptacles 60 is 2 feet, then the overall length of the span must be divisible for 2 feet. In other words, any spacing between each of the plurality of receptacles 60 is contemplated herein, as long as the overall length of the span allows for the uniform spacing to remain present. Please note that within this disclosure, the length of 5 feet (or 60”) is frequently referred to as the spacing for each of the plurality of receptacles, although in accordance with aspects herein, any of the spacings discussed herein are able to be substituted in place of the 5 feet receptacle spacing length.

Generally, it is advantageous to use the smallest number of fluid delivery conduits 14 within a single span or irrigation system 10. However, there instances where using a larger number of fluid delivery conduits 14 may allow for increased length variability or structural rigidity. For example, there may exist an application in which a non-standard length of a span or irrigation system 10 may be desired. In this case, the desired non-standard length may only be achieved through the use of numerous smaller fluid delivery conduits 14. However, as all the fluid delivery conduits 14 are of the same standard 38’ length, the receptacle spacing remains uniform across all of the fluid delivery conduits 14. But, span lengths may only be modified in multiples of 5’, to maintain the uniform receptacle spacing.

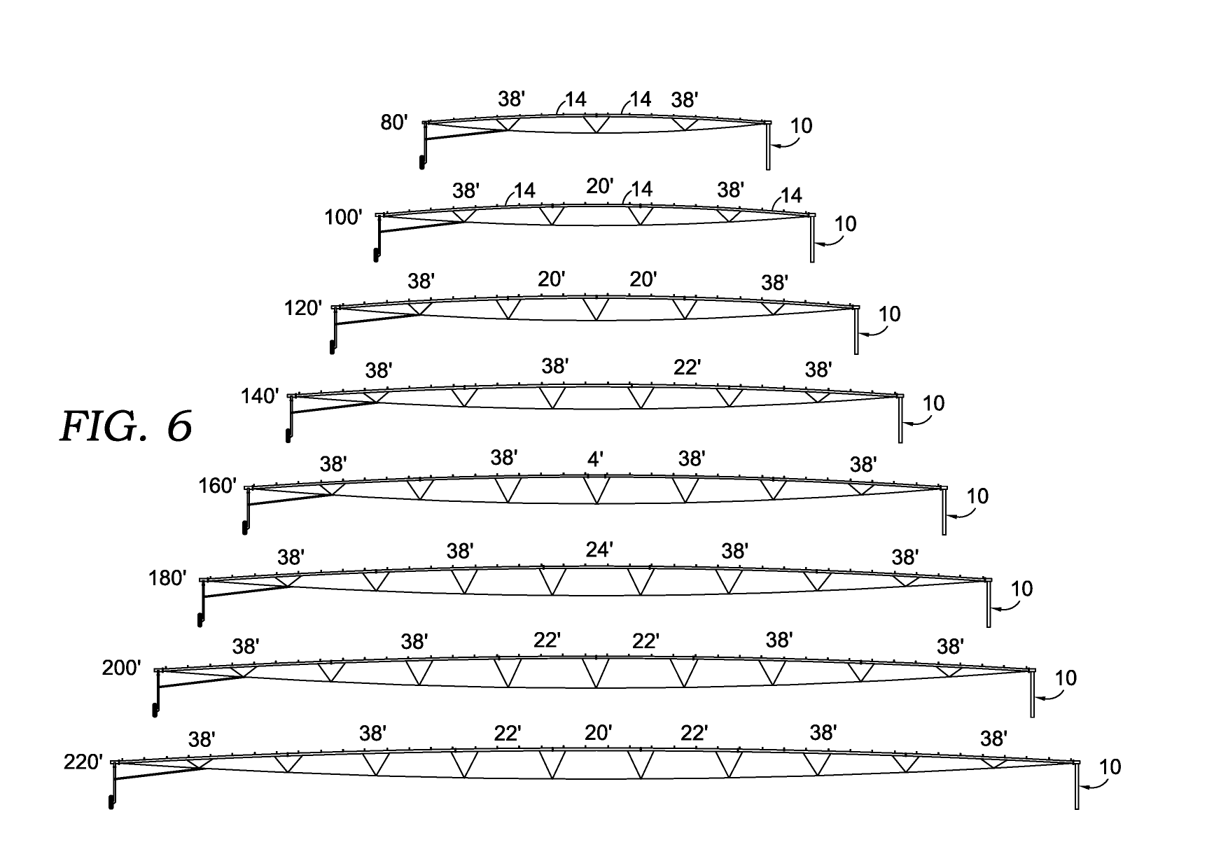

Turning now to FIG. 6, a schematic side elevation view is provided where a plurality of variable length spans are depicted having a plurality of receptacles 60 spaced in accordance with the present invention. In FIG. 6, the fluid delivery conduits 14 are of different lengths across the overall length of the span. For example, the 100’ span contains two standard 38’ fluid delivery conduits 14 spaced apart by and connected together with one intermediate 20’ fluid delivery conduit 14. Moving down the page, each of the plurality of fluid delivery conduits 14 contain a combination of standard 38’ fluid delivery conduits, and other non-standard sized fluid delivery conduits 14. For example, the 140’ span contains three 38’ fluid delivery conduits 14 and one 22’ fluid delivery conduit 14. In another example, the 160’ span contains four 38’ fluid delivery conduits 14 and one 4’ fluid delivery conduit 14. Any combination of standard sized 38’ fluid delivery conduits 14 and non-standard sized fluid delivery conduits 14 (of any length) may be combined to create a desired overall length of a span. Regardless of the desired overall length of the span, each span still has a first end segment 20 at its first end 40 and a second end segment 22 at its second end 42. The first end segment 20 is coupled to the fluid source 12 or the second end segment 22 of an adjoining additional span. The second end segment is coupled to the first end segment 20 of an adjoining prior span or to an ancillary span or a swing arm.

As discussed herein, the first end segment 20 and the second end segment 22 are sized to be two feet in length (plus or minus 10%), such that when multiple spans are connected to each other, the spacing of the plurality of receptacles 60 remains constant from one span to the adjacently-connected span. For example, in FIG. 6, if the 80’ span and the 100’ span are coupled to each other, the sizing of the first end segment 20 and the second end segment 22 allows for the spacing of the plurality of receptacles 60 to remain constant across the connection between the spans that have been coupled together. By having a constant spacing of the plurality of receptacles 60 across multiple spans, this reduces the number of “dead zones”, in which crops receive no, little, or excess active water supply. In other words, in prior art irrigation systems, the coupling of multiple spans together of non-standard lengths would result in “dead zones” (i.e., areas where the receptacles are closer than normal or further apart than normal) at the location of coupling, because the constant spacing of the plurality of receptacles 60 gets interrupted by the sizing of the coupling joints. However, in accordance with the invention of this application, the first end segment 20 and the second end segment 22 are sized, along with the positioning of the receptacles 60 along each fluid delivery conduit 14, to prevent a “dead zone” from arising. By having the first end segment 20 and the second end segment 22 having the appropriate size (2 feet) in the present application, the spacing of the plurality of receptacles 60 remains a constant 5 feet across the connections of multiple spans, as well as along each span, for the length of the irrigation system 10.

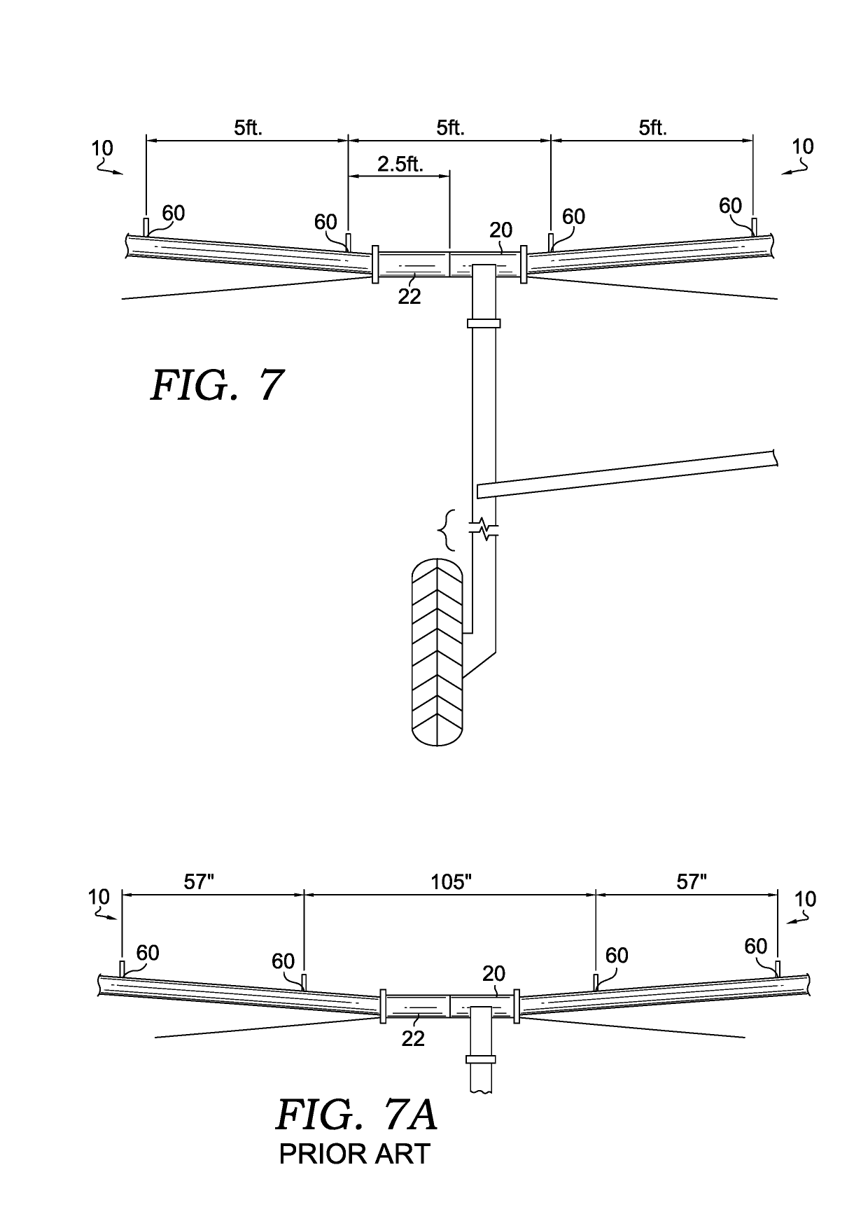

The concept of preventing “dead zones” (areas which receive no, little, or excess active water supply) is best illustrated within FIGS. 7 and 7A. FIG. 7A depicts a prior art coupling of two spans, depicting the non-uniform spacing of receptacles 60 that happens when two prior art spans are coupled together. Note the spacing between adjacent receptacles 60 is non-uniform due to the sizing of the prior art spans or the presence of the first end segment 20 and second end segment 22. On the other hand, FIG. 7 depicts two spans of the irrigation system 10 that have been coupled together in accordance with aspects of the present invention. The span on left side of FIG. 7 and the span on the right side of FIG. 7B are coupled together by a first end segment 20 and a second end segment 22. In accordance with aspects of the present invention, the length of each of the first end segment 20 and the second end segment 22 is two feet, and the spacing between each of the plurality of receptacles 60 is 5 feet. Thus, there is roughly a ½ foot gap between each of the final receptacles 60 and the first end segment 20 and the second end segment 22. In sizing each of the first end segment 20 and the second end segment 22 this way, the spacing between each of the plurality of receptacles 60 remains constant (5 feet) across the connection of the two spans, even though they have been coupled together.

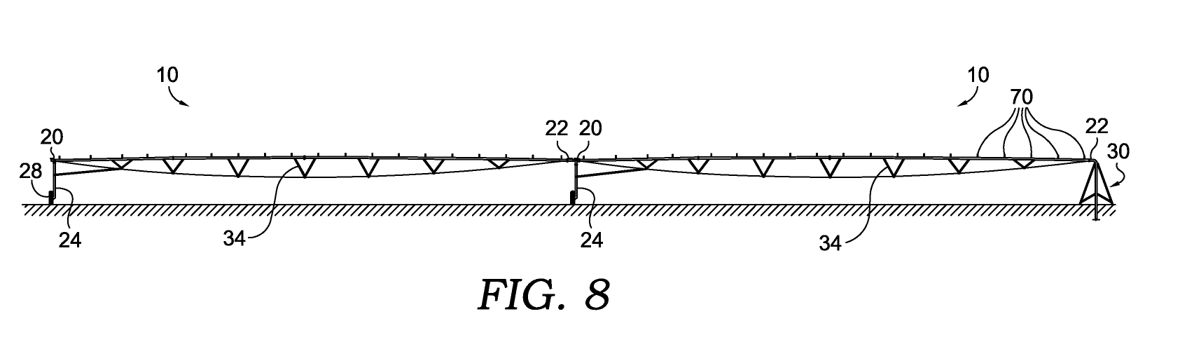

Turning now to FIG. 8, a side elevation view of two spans coupled together is presented, in accordance with aspects of the invention. The coupling between the spans occurs at the first end segment 20 and the second end segment 22, and are appropriately sized to prevent a “dead zone” from arising. As depicted in FIG. 8, the spacing between each of the plurality of receptacles 60 remains constant across each span within the irrigation system 10. On the right portion of the illustration, a stationary tower 30 is depicted as providing the fluid source 12 to the array of spans, and on the left portion of the diagram, a mobile tower 24 with a wheel 28 is depicted as allowing for the array of spans to pivot and rotate around the stationary tower 30. As discussed herein, the first end segment 20 and the second end segment 22 are approximately two feet in length (plus or minus 10% for tolerancing), such that the spacing between each of the plurality of receptacles 60 remains 5 feet. Moreover, as depicted in FIG. 8, each of the plurality of receptacles 60 contains a water distribution mechanism 70, depicted in FIG. 8 as a sprinkler. It is within the scope of this disclosure to have other types of water distribution mechanisms 70 coupled to the plurality of receptacles 60. The general goal of the water distribution mechanism is to disperse water (or another type of liquid) in an efficient manner, across a large area.

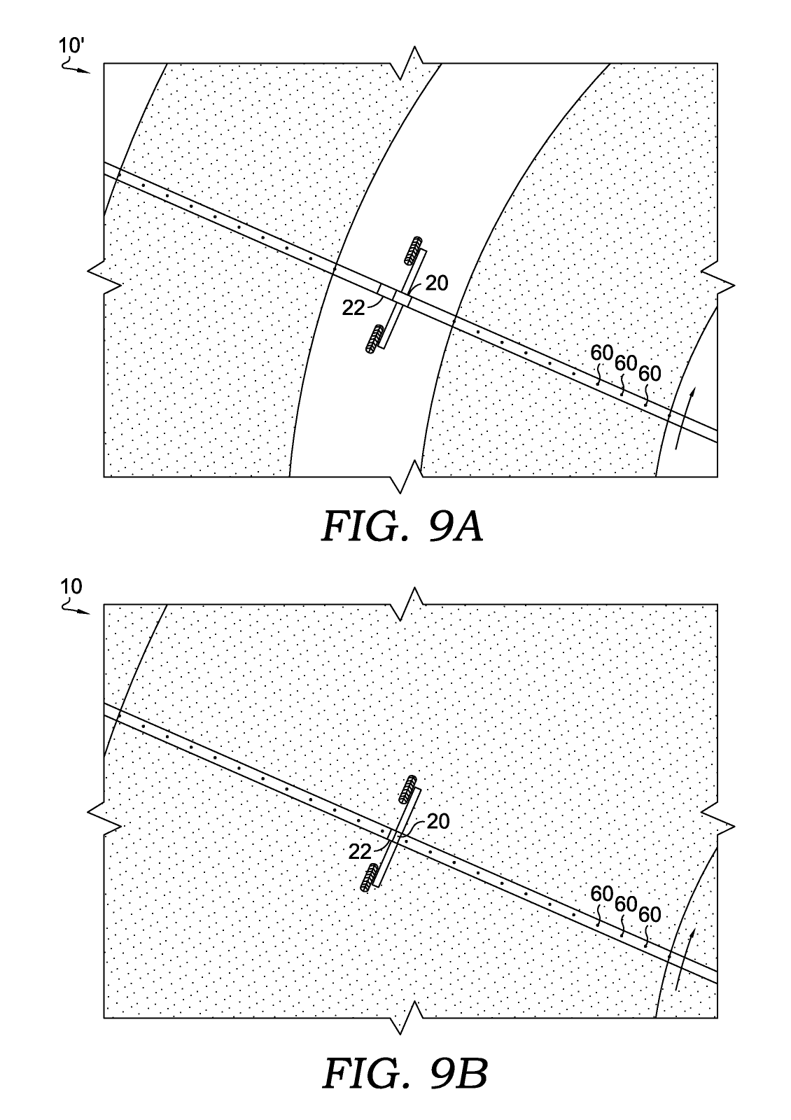

Turning now to FIG. 9A, an environmental top view of a prior art irrigation system 10’is depicted. FIG. 9B provides an environmental top view of an irrigation system 10 constructed in accordance with the present invention. As depicted in FIG. 9A, the constant spacing between the plurality of receptacles 60’ along the span is interrupted when the two spans 10 are coupled together. This leads to the creation of a “dead zone”, in which water (or another fluid) does not touch every portion of the ground in the area within the radius of the prior art irrigation system 10’. By contrast, in FIG. 9B, the irrigation system 10 of the present invention maintains a constant spacing between the plurality of receptacles 60 across the connection between two spans, such that water (or another fluid) touches every portion of the ground in the area within the radius of the irrigation system 10 of this application. The stippled portions of FIGS. 9A and 9B represent agricultural areas which would receive water and the areas without stippling represent the agricultural areas which would not receive any water or very little water. FIG. 9A represents the issues with the prior art irrigation systems, in which the sizing of the prior art first end segment 20’ and prior art second end segment 22’ prevents the water distribution from reaching the entirety of the surrounding crops. However, in FIG. 9B (which represents the invention of the present application), the sizing of the first end segment 20 and the second end segment 22 allows the plurality of receptacles 60 to span the length of the plurality of fluid delivery conduits 14. By doing so, the fluid that comes from the plurality of fluid delivery conduits 14 covers the entire ground beneath (as illustrated by the stippling in FIG. 9B).

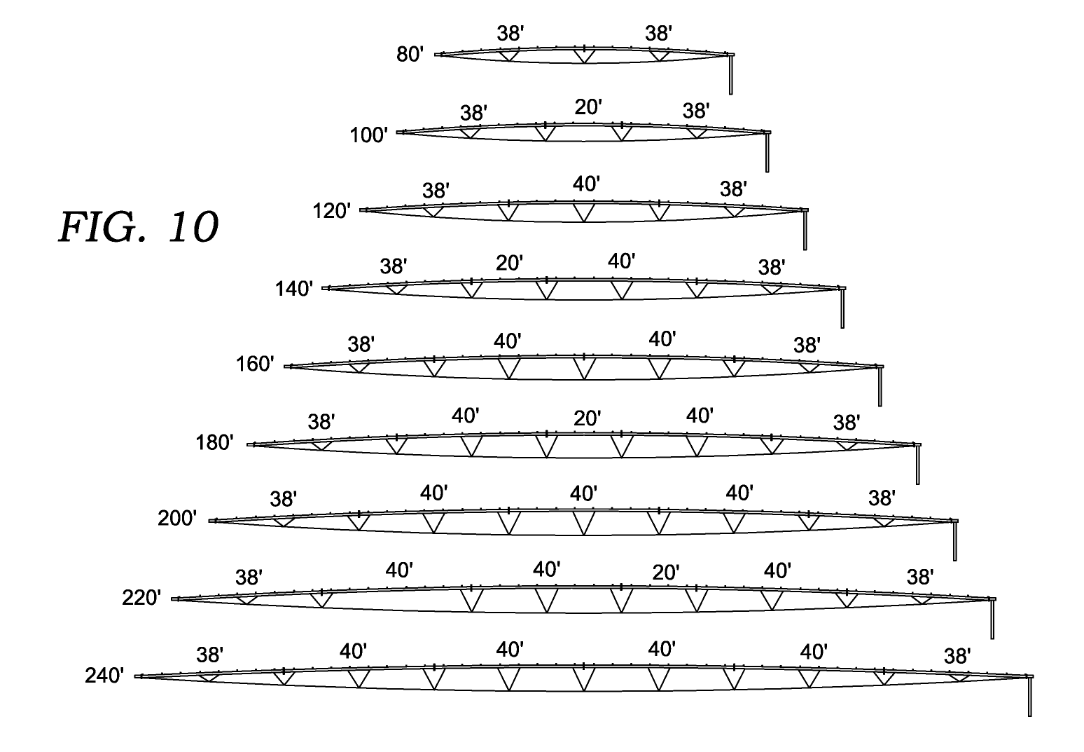

In FIG. 6, the plurality of pipe segments 14 are generally depicted as having lengths of 4’, 20’, 22’ or 38’, in accordance with aspects herein. This combination of pipe segments 14 with the receptacle spacing thereon permits pipe segments 14 of only four different lengths to provide for span lengths of 80’ to 220’ in 20’ increments with uniform receptacle spacing across adjoining pipe segments 14 and across adjoining spans. Further, each of the four pipe segments 14 are of a length that easily fits into a standard shipping container. However, it should be understood that the lengths of these pipe segments 14 is merely exemplary for one embodiment of the concepts of the present invention. The concepts of the present invention described herein may be used with pipe segments 14 of different lengths and still be within the scope of this disclosure. For example, FIG. 10 depicts a schematic side elevation view of an alternate embodiment of a variable length span of an irrigation system having uniformly spaced receptacle portions and uniform pipe lengths. In this embodiment the receptacles 60 are spaced on 60” intervals and the lengths of some of the fluid delivery conduits 14 are different in some of the overall spans when compared to FIG. 6. The span lengths in FIG. 10 are accomplished through the use of individual pipe segment lengths that are 20’, 38’ and 40’. Accordingly, this embodiment provides for pipe segments of only three different lengths to provide for span lengths of 80’ to 240’ in 20’ increments while still providing uniform receptacle spacing across adjoining pipe segments 14 and across adjoining spans.

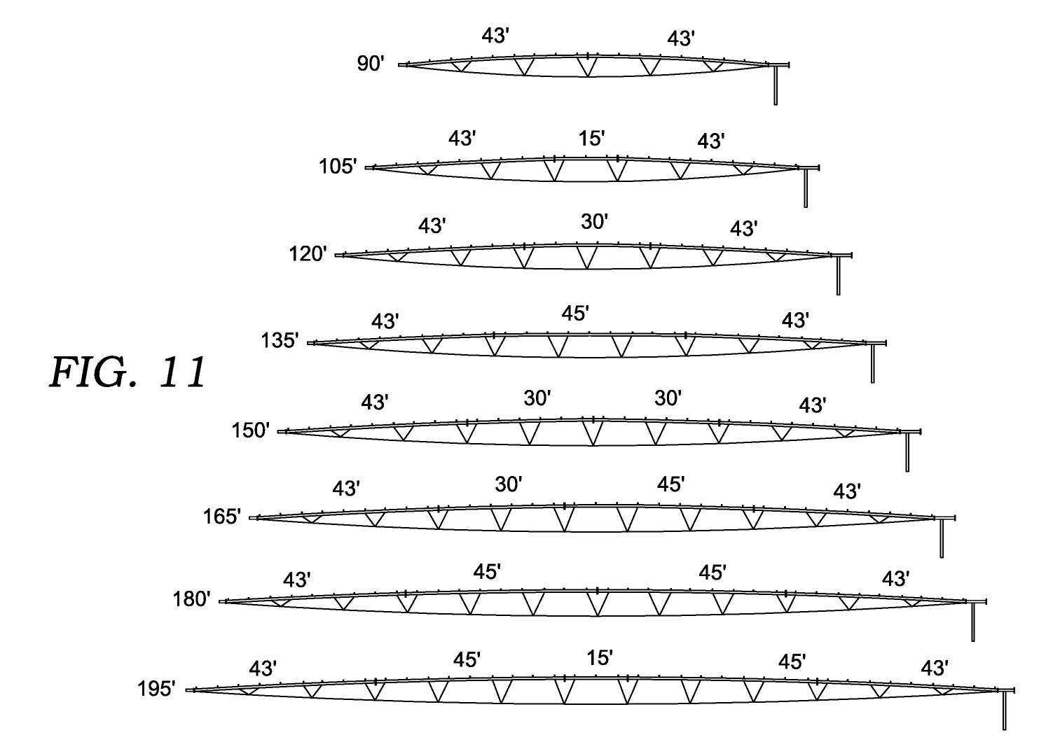

FIG. 11 depicts a schematic side elevation view of yet another embodiment of the present invention. In this embodiment, unlike those in FIGS. 6 and 10 where the span lengths were in 20’ increments, the overall lengths of the spans run from 90’ to 195’ in 15’ increments. This is accomplished by utilizing individual pipe segments of 15’, 30’, 43’ and 45’. Accordingly, in this illustrated embodiment, pipe segments of only four different lengths are needed to provide the entire range of span lengths, thereby minimizing the number of standard pipe lengths needed for the family of span lengths while still providing for uniform receptacle across the entire length of the irrigation unit. As discussed herein, the overall lengths of the spans, as well as the lengths of the individual pipe segments is variable depending on the needs of the user. Therefore, it should be understood that the lengths depicted herein are merely examples, rather than a rigid representation of dimensions of the invention. Most importantly, the actual values of the overall span lengths and individual pipe segments allows for a uniform distribution of the plurality of receptacles 60. It should be understood that these embodiments are merely exemplary, and that other overall span lengths and lengths of individual pipe segments are contemplated to be within the scope of this disclosure.

Additionally, although some exemplary implementations of the embodiments described herein are shown in the accompanying figures, these implementations are not intended to be limiting. Rather, it should be understood that the various embodiments and aspects described herein may be implemented upon any irrigation system having a plurality of receptacles along a span.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

What is claimed:

1. An irrigation system having a variable overall length, the irrigation system comprising:
a plurality of fluid delivery conduits having a plurality of receptacles spaced along the plurality of fluid delivery conduits, wherein the plurality of fluid delivery conduits define a span having a first peripheral end and a second peripheral end;
a first end segment coupled to the first peripheral end and a second end segment coupled to the second peripheral end, each of the first end segment and the second end segment having a length that is shorter than a distance between two of the plurality of receptacles;
a trussing system coupled to the first peripheral end and the second peripheral end of the span, wherein the trussing system comprises a plurality of support structures coupled to the plurality of fluid delivery conduits;
wherein each of the plurality of receptacles are spaced apart by a uniform distance; and
wherein the length of the first end segment and the length of the second end segment is less than half of the uniform distance by which each of the plurality of receptacles is spaced apart.

2. The irrigation system of claim 1, wherein the plurality of fluid delivery conduits comprises between two and ten individual fluid conduits coupled together.

3. The irrigation system of claim 2, wherein the plurality of fluid delivery conduits comprises at least one individual fluid conduit having a first length, and wherein the plurality of fluid delivery conduits comprises at least one individual fluid conduit having a second length that is smaller than the first length.

4. The irrigation system of claim 3, wherein the first length of the at least one individual fluid conduit is between 38 feet and 45 feet.

5. The irrigation system of claim 3, wherein the plurality of fluid delivery conduits comprises at least one individual fluid conduit having a third length that is less than the first length and the second length.

6. The irrigation system of claim 1, wherein the uniform distance by which each of the plurality of receptacles is spaced apart is between 20” and 60” in length.

7. The irrigation system of claim 1, wherein the first end segment and the second end segment are between 2-3. feet in length.

8. The irrigation system of claim 1, further comprising a movable tower having a set of wheels coupled to the tower at either of the first peripheral end or the second peripheral end of the plurality of fluid delivery conduits.

9. The irrigation system of claim 1, wherein the overall length of the span is between 80-240. feet in lengths evenly divisible by the uniform distance the plurality of receptacles are spaced apart, wherein each of the lengths of the span has between two and ten fluid delivery conduits, and wherein each of the fluid delivery conduits is one of only five different lengths.

10. The irrigation system of claim 1, wherein the length of the first end segment and the second end segment are sized to maintain the uniform distance by which the plurality of receptacles is spaced apart.

11. An array of spans coupled together to form an irrigation system, comprising:
at least a first span and a second span, each of the first span and the second span comprising:
a plurality of fluid delivery conduits connected end to end, each having a plurality of receptacles spaced uniformly there along by a uniform distance, wherein the connected plurality of fluid delivery conduits define a first peripheral end and a second peripheral end;
a first end segment coupled to the first peripheral end and a second end segment coupled to the second peripheral end, each of the first end segment and the second end segment having a length that is shorter than half of the uniform distance between the uniformly spaced receptacles; and
a trussing system coupled to the first peripheral end and the second peripheral end of the connected plurality of fluid delivery conduits, wherein the trussing system comprises a plurality of support structures coupled to the plurality of fluid delivery conduits; wherein the second end segment of the first span and the first end segment
of the second span are coupled together; and
wherein the uniform distance between the plurality of receptacles is maintained across the coupling of the second end segment of the first span to the first end segment of the second span.

12. The array of spans of claim 11, wherein the plurality of fluid delivery conduits of each of the first and second spans comprises between two and seven individual fluid conduits coupled together.

13. The array of spans of claim 12, wherein the plurality of fluid delivery conduits of each of the first and second spans comprises at least one individual fluid conduit having a first length and another individual fluid conduit having a second length that is smaller than the first length.

14. The array of spans of claim 13, wherein the first length of the at least one individual fluid conduit is 38 feet.

15. The array of spans of claim 13, wherein the second length of the another individual fluid conduit is selected from a group comprising 4 feet, 20 feet, 22 feet and 24 feet.

16. The array of spans of claim 11, wherein the uniform distance by which each of the plurality of receptacles is spaced apart is between 20” and 60” in length.

17. The array of spans of claim 11, wherein the first end segment and the second end segment are between 2-3. feet in length.

18. The array of spans of claim 11, further comprising a mobile tower having a set of wheels, wherein the mobile tower is coupled to either of the first peripheral end or the second peripheral end of the connected plurality of fluid delivery conduits of the first span and the second span.

19. The array of spans of claim 11, wherein the variable overall length of each of the first span and the second span is between 80-240. feet in lengths evenly divisible by the uniform distance the plurality of receptacles are spaced apart, wherein each of the lengths of the span has between two and seven fluid delivery conduits, and wherein each of the fluid delivery conduits is one of only five different lengths.

20. The array of spans of claim 11, wherein the length of the first end segment and the second end segment of the first span and the second span is sized to maintain the uniform distance by which the plurality of receptacles is spaced apart when the first span is coupled to the second span.
